(19) United States
(12) Patent Application Publication
(10) Pub. No.: US 2013/0172462 A1
(43) Pub. Date: Jul. 4, 2013

(54) POLYOLEFINS WITH ORGANOCLAY AND FLUOROPOLYMER ADDITIVES

(71) Applicants: AYUBA ADEGOKE ADESINA, DHAHRAN (SA); IBNEL WALEED ALI HUSSEIN, DHAHRAN (SA)

(72) Inventors: AYUBA ADEGOKE ADESINA, DHAHRAN (SA); IBNEL WALEED ALI HUSSEIN, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/342,925

(22) Filed: Jan. 3, 2012

(51) Int. Cl. C08K 5/54

(52) U.S. Cl. 524/262

(57) ABSTRACT

The polyolefin with organoclay and fluoropolymer additives improves the processing characteristics of the polyolefin for melt extrusion. Between about 200 and about 1,000 ppm/weight organoclay (0.02-0.1 percent by weight) and between about 200 and about 1,000 ppm/weight (0.02-0.1 percent by weight) fluoropolymer are mixed with a polyolefin resin, such as high-density polyethylene (HDPE), in order to improve the extrusion processing characteristics of the polyolefin.

### BACKGROUND OF THE INVENTION

1. Field of the Invention

The present invention relates to methods for extruding polyolefins, and particularly to polyolefins with organoclay and fluoropolymer additives that provides for the addition of small quantities of organoclay and fluoropolymer to the polyolefin to improve the processing characteristics of the polyolefin during extrusion.

2. Description of the Related Art

Due to the broad applications of polyolefins, such as high-density polyethylene (HDPE), there is great interest in the enhancement of the material properties and processability of polyolefins, particularly in the extrusion thereof. Various techniques have been applied over the years, such as increasing the temperature of the processed materials along the extrusion line, modification of the extruder (particularly of the die head), conditioning the die surface of the extruder, and modification of the polymer itself. Such modifications have had varying levels of success.

In recent years, the introduction of processing additives to the host polymers has gained interest in the field of polymer processing. Fluoropolymer, boron nitride and organoclay have each been used, singly, as additives in the production process, with limited success in enhancing the processing properties of the end polyolefin. Although some enhancement has been found, the expense and increase in processing time for limited results have yet to make such additives of practical value.

Thus, a polyolefin with organoclay and fluoropolymer additives and a method of making the same solving the aforementioned problems are desired.

### SUMMARY OF THE INVENTION

The present invention relates to polyolefins, and particularly to the addition of organoclay and fluoropolymer to the polyolefin to improve the processing characteristics of the polyolefin during extrusion. Between about 200 and about 1,000 ppm organoclay (0.02-0.1 percent by weight) and between about 200 and about 1,000 ppm (0.02-0.1 percent by weight) fluoropolymer are mixed with a polyolefin, such as high-density polyethylene (HDPE) during extrusion in order to improve the processing characteristics of the polyolefin.

In order to make the polyolefin composition, a polyolefin resin is first ground, and then mixed with the organoclay and the fluoropolymer to form a composition in which the organoclay forms between about 0.02 and about 0.1 percent by weight of the composition, and the fluoropolymer forms between about 0.02 and about 0.1 percent by weight of the composition.

An antioxidant is preferably also mixed with the fluoropolymer, the ground polyolefin and the organoclay. The antioxidant forms about 0.1 percent by weight of the composition. The antioxidant is provided to avoid degradation during melt blending. The melt blending is performed at a temperature of about 200° C. for about ten minutes at a mixer or extruder screw speed of about 50 rpm.

These and other features of the present invention will become readily apparent upon further review of the following specification and drawings.

### BRIEF DESCRIPTION OF THE DRAWINGS

FIG. 1A is a side view in section of a single screw extruder used to test the polyolefins with organoclay and fluoropolymer additives according to the present invention.

FIG. 1B is a perspective view of a slit die of the single screw extruder of FIG. 1A.

FIG. 2A is a plot comparing a ratio of standard deviation and mean pressure against shear rate for samples of HDPE, HDPE containing organoclay, HDPE containing fluoropolymer, and HDPE containing both organoclay and fluoropolymer additives.

FIG. 2B is a plot comparing distortion factor as a function of shear rate for samples of HDPE, HDPE containing organoclay, HDPE containing fluoropolymer, and HDPE containing both organoclay and fluoropolymer additives.

FIG. 3 is a plot comparing shear stress as a function of shear rate for samples of HDPE, HDPE containing organoclay, HDPE containing fluoropolymer, and HDPE containing both organoclay and fluoropolymer additives.

Similar reference characters denote corresponding features consistently throughout the attached drawings.

### DETAILED DESCRIPTION OF THE PREFERRED EMBODIMENTS

The present invention relates to polyolefins, and particularly to the addition of organoclay and fluoropolymer to the polyolefin to improve the processing characteristics of the polyolefin for extrusion of the polyolefin. Between about 200 and about 1,000 ppm/weight organoclay (0.02-0.1 percent by weight) and between about 200 and about 1,000 ppm/weight (0.02-0.1 percent by weight) fluoropolymer are mixed with a polyolefin, such as high density polyethylene (HDPE), in order to improve the extrusion processing characteristics of the polyolefin. It will be understood that an organoclay is a naturally occurring clay mineral that has been modified to exchange the original interlayer cations for a layer of covalently linked organic moities, such as quaternary alkylammonium ions.

In the following example, commercial grade high density polyethylene (HDPE) was used, with a relative density of 0.952, a melting point of 132° C., and a melt flow index of 0.05 g/10 mins at 190° C. with a 2.16 kg load. The average-weight molecular weight M_{w} and polydispersity index (PDI) were 285 kg/mol and 26.5, respectively. The organoclay used was Cloisite® 15A (C15A) manufactured by Southern Clay Products, Inc. of Gonzales, Tex. The d₀₀₁ spacing of C15A is 31.5 Å. Cloisite® 15A is a natural montmorillonite modified with a quaternary ammonium salt. Dynamar®, manufactured by Dyneon®, LLC of North Oakdale, Minn., was used to represent a free-flowing fluoropolymer. Dynamar® is a copolymer of hexafluoropropylene (HFP), vinylidene fluoride (VF₂) and tetrafluoroethylene (TFE). Dynamar® has a bulk density of 0.7. An antioxidant (0.1 wt %) was added to all samples to avoid degradation during melt blending. The particular antioxidant was a 50/50 weight blend of Irganox® 1010 and Irgafos® 168, both manufactured by Ciba Specialty Chemicals Corporation of Tarrytown, N.J.

A Brabender® 50 EHT mixer, manufactured by C. W. Brabender Instruments, Inc. of South Hackensack, N.J., was used in the preparation of the nanocomposites. The mixer was provided with a plastograph, which is a device for the continuous observation of torque in the shearing of a polymer with a range of temperatures and shear rates. The HDPE was ground and pre-mixed with each processing additive. The antioxidant was added during the physical mixing. A master batch containing organoclay and fluoropolymer was then prepared in the Brabender® 50 EHT mixer. The desired final concentration of a particular blend was obtained by mixing additional virgin HDPE with the master batch using the same mixer. The blending was performed at a temperature of 200° C. and a screw speed of 50 RPM for ten minutes. In the following, HDPE-C15A, HDPE-Fluoro and HDPE-C15A-Fluoro refer to HDPE containing organoclay, fluoropolymer and combined organoclay and fluoropolymer, respectively.

The structures of the nanocomposites were characterized by field emission scanning electron microscopy (FE-SEM) and X-ray diffractometry (XRD). The XRD analysis was performed on XRD-6000 diffractometer, manufactured by the Shimadzu® Corporation of Kyoto, Japan. The XRD analysis was performed with CuKα radiation (λ=0.154 nm) in a reflection mode, operating at 40 kV and 30 mA. A scanning speed of 1°/min was used. The scan range was 2-20° at room temperature. Scanning electron micrographs were obtained with an FE-SEM Nova Nanosem® 230, manufactured by General Nanotechnology, LLC of Berkeley, Calif. The Nova Nanosem® 230 provides ultra-high resolution on non-conductive nano-materials. The SEM samples were made into thin films and etched for four hours. The etching solution was a solution of H₂SO₄/H₃PO₄/H₂O (10/4/1) and 0.01 g/ml KMnO₄. The etched samples were further covered with gold to make them conductive.

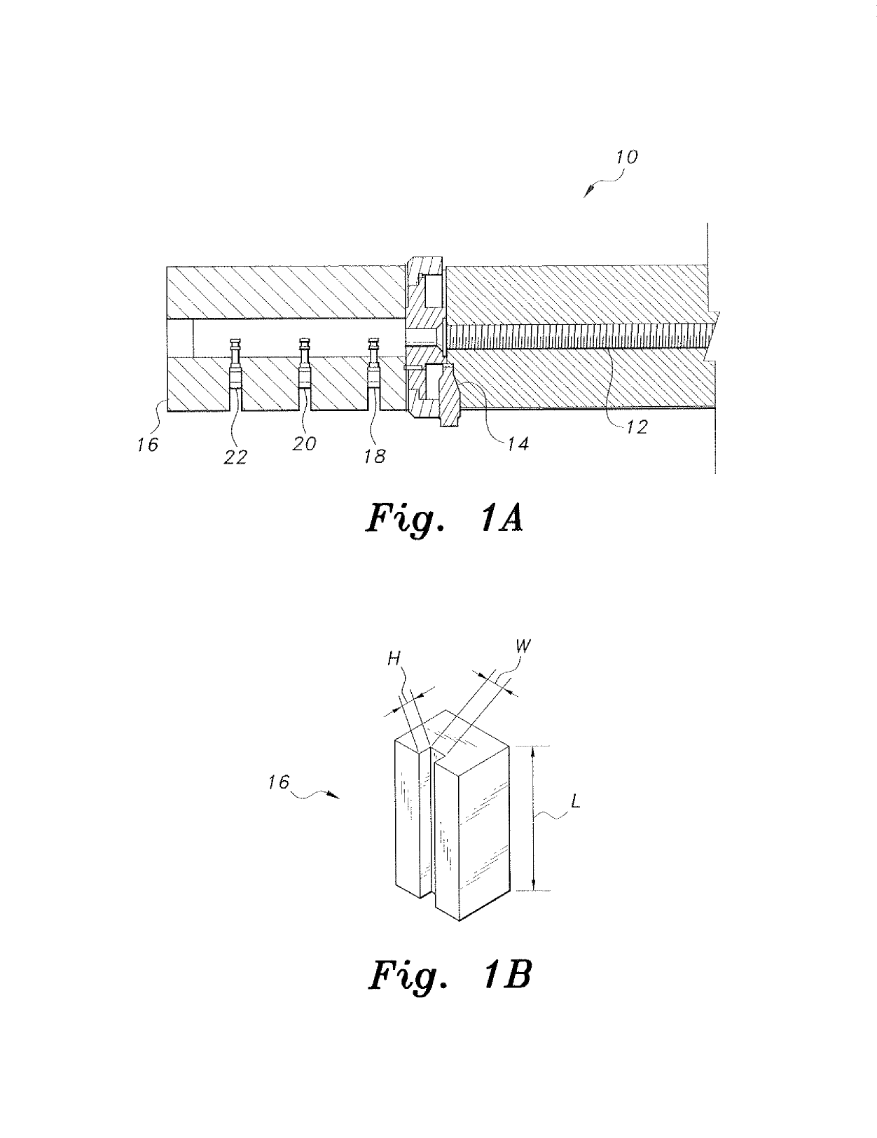

Extrusion was performed in a single screw extruder (model 19/25D manufactured by C. W. Brabender Instruments, Inc. of South Hackensack, N.J.) equipped with a specially developed slit die. FIG. 1A illustrates such an extruder system 10, with a single screw extruder 12, a pressure transducer 14 and a slit die 16. The slit die 16 is best seen in FIG. 1B. The slit die has dimensions of 0.8 mm in height H, 20 mm in width W and 160 mm in length L. The slit die 16 has three highly sensitive piezoelectric transducers 18, 20, 22, positioned at 30 mm, 80 mm and 140 mm, respectively, from the entrance of the die. The pressure and time resolutions of these transducers are on the order of 10⁻¹ mbar and 1 ms, respectively. The temperature of the three heater bands along the extruder were 180° C., while the temperature of the die was 170° C. The pressure fluctuations from the piezoelectric transducers were further analyzed using moment (standard deviation and mean pressure) and Fourier transform (FT) analyses. The FT analysis is based on the following:

$$p ( t ) = \overline{p} + {\sum }_{i \geq 1} {l}_{i} cos ( {w}_{i} t + {φ}_{i} ) , \qquad ( 1 )$$

where p̅ is the pressure mean value at

$$\frac{w}{2 π} , and \frac{{w}_{i}}{2 π} ,$$

φᵢ and lᵢ are the characteristic frequencies, phases, and amplitudes of the pressure fluctuation as quantified from the Fourier analysis of the processed signals, respectively. One of the most important parameters from the FT analysis in quantifying melt instabilities is the distortion factor (DF). This is a measure of the relative pressure fluctuation (RPF), and is given as:

$$DF = \frac{{\sum }_{i \geq 1} {l}_{i}}{{l}_{0}} , \qquad ( 2 )$$

where l₀ is the peak value at w=0, and is related to the pressure mean value.

In addition to the above, a study on the extrusion pressure at relatively high shear rates was performed in a continuous MiniLab II Rheomex® CTW5, manufactured by Haake, Inc. of Saddle Brook, N.J. The MiniLab H Rheomex® CTW5 is a 5/14 diameter conical counter rotating twin screw extruder with a backflow channel. The backflow channel was designed as a slit capillary (64 mm×10 mm×1.5 mm) with two pressure transducers at the capillary entrance and exit. End entrance effects were avoided since the transducers were positioned away from the ends.

The maximum allowable pressure of the transducers at the entrance and exit of the backflow channel were 200 and 100 bar, respectively. The maximum obtainable screw speed was 360 RPM. To study the effect of organoclay, fluoropolymer and their combination on the extrusion pressure, the speed of the screw was varied from 20 to 360 RPM. The samples were introduced into the MiniLab II Rheomex® CTW5 in three steps with 2-3 ml fed-in during each step. It should be noted that the MiniLab H Rheomex® CTW5 was only used for comparative study between samples.

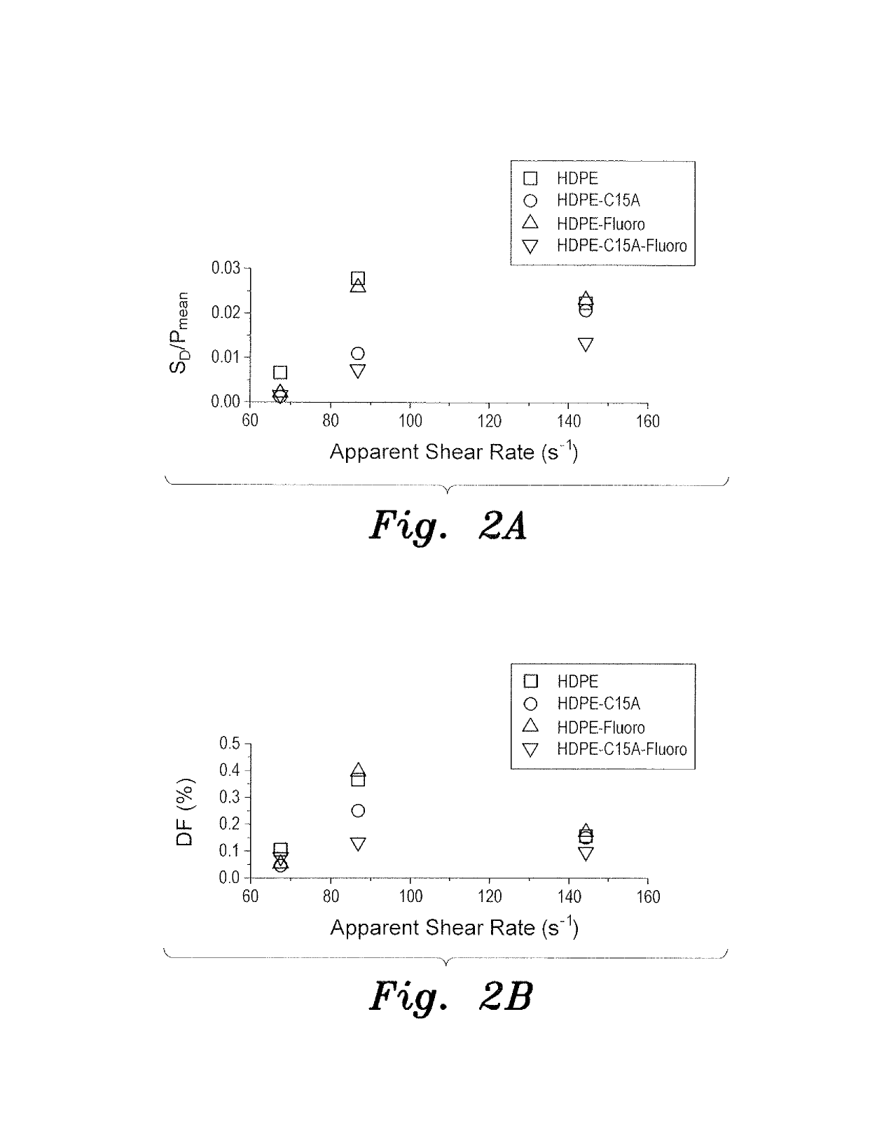

FIG. 2A is a plot comparing a ratio of standard deviation S_{D}, and mean pressure Pₘₑₐₙ against shear rate (measured in s⁻¹) for samples of HDPE, HDPE containing organoclay, HDPE containing fluoropolymer and HDPE containing both organoclay and fluoropolymer additives. As shown, the present HDPE with both organoclay and fluoropolymer additives exhibits the lowest ratio for each sampled shear rate. Similarly, FIG. 2B is a plot comparing distortion factor DF as a function of shear rate for the samples of HDPE, HDPE containing organoclay, HDPE containing fluoropolymer and HDPE containing both organoclay and fluoropolymer additives. The HDPE with both organoclay and fluoropolymer additives has the lowest DF at each sampled shear rate. These measurements were taken at the third transducer 22.

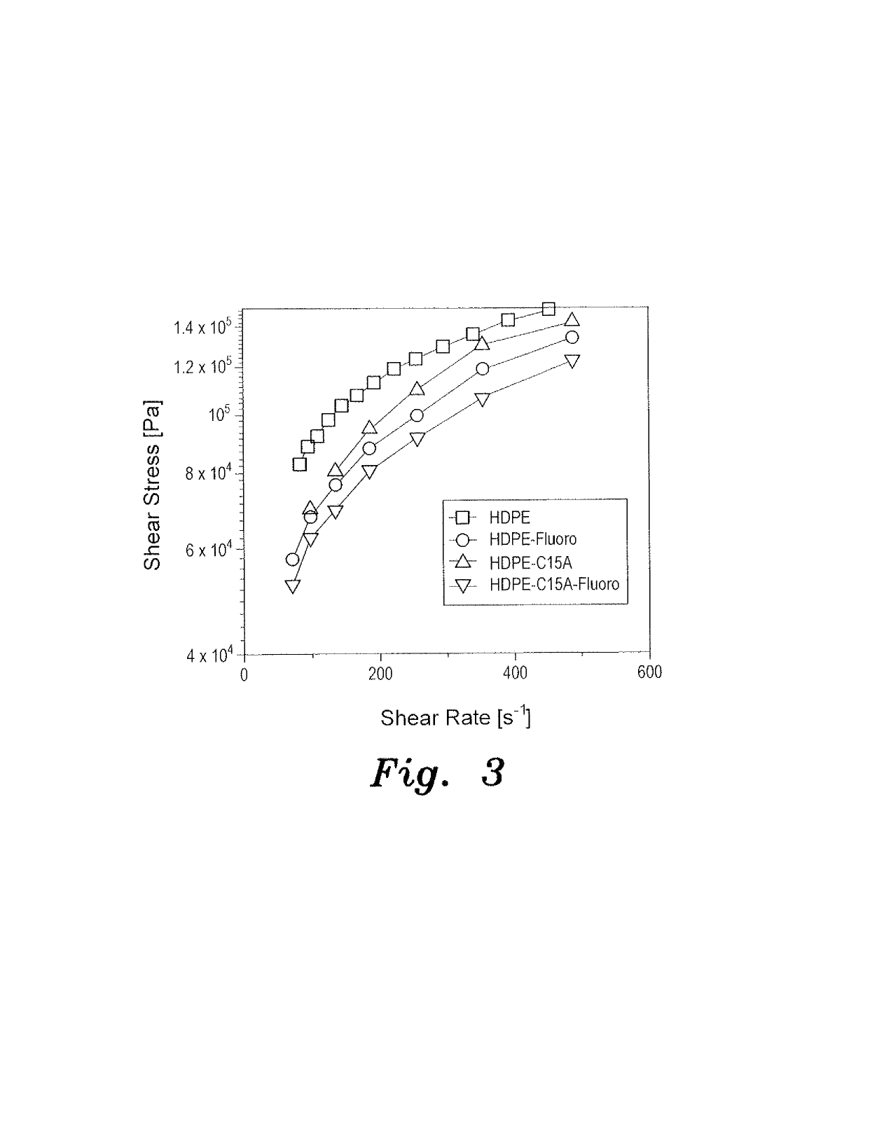

FIG. 3 shows the shear stress as a function of shear rate. As expected from the above, the shear stress at each sampled shear rate is found to be lowest for the HDPE containing both the organoclay and fluoropolymer additives. This was measured by the MiniLab II Rheomex® CTW5 at a temperature of about 160° C.

It will be understood that the composition and method described herein may be implemented by compounding the organoclay and fluoropolymers with a polyolefin mixer, followed by pelletizing the resulting compound with a pellet extruder to form a polyolefin resin with the additives compounded therein in the proper proportions for subsequent use with a melt extruder; by mixing the additives with the polyolefin resin in the hopper of a melt extruder for blending in the barrel of the extruder; or by any other method known in plastics manufacturing for compounding additives with a resin for processing by melt extrusion.

It is to be understood that the present invention is not limited to the embodiments described above, but encompasses any and all embodiments within the scope of the following claims.

We claim:

1. A polyolefin compound for processing by extrusion, comprising a composition having:
between about 0.02 and about 0.1 percent by weight of an organoclay additive;
between about 0.02 and about 0.1 percent by weight of a fluoropolymer; and
a polyolefin resin forming the balance of the composition.

2. The polyolefin composition as recited in claim 1, wherein the polyolefin resin is high-density polyethylene.

3. The polyolefin composition as recited in claim 2, further comprising about 0.1 percent by weight of an antioxidant added to the composition.

4. The polyolefin composition as recited in claim 3, wherein the organoclay comprises montmorillonite modified with a quaternary ammonium salt.

5. A method of making a polyolefin composition, comprising the steps of:
grinding a polyolefin resin;
mixing the ground polyolefin resin with an organoclay additive;
mixing a fluoropolymer additive with the ground polyolefin resin and the organoclay to form a polyolefin composition having the organoclay between about 0.02 and about 0.1 percent by weight and the fluoropolymer between about 0.02 and about 0.1 percent by weight, the balance being the polyolefin resin; and
blending the composition to compound the additives with the polyolefin resin.

6. The method of making a polyolefin composition as recited in claim 5, wherein the polyolefin resin comprises high-density polyethylene.

7. The method of making a polyolefin composition as recited in claim 5, further comprising the step of mixing an antioxidant with the fluoropolymer, the ground polyolefin and the organoclay, the antioxidant comprising about 0.1 percent by weight of the composition.

8. The method of making a polyolefin composition as recited in claim 5, wherein the step of blending the additives with the polyolefin resin is performed at a temperature of about 200° C.

9. The method of making a polyolefin composition as recited in claim 5, wherein the step of blending the additives with the polyolefin resin comprises blending the additives through a single screw mixer at a screw speed of about 50 RPM.
